(19) United States
(12) Patent Application Publication
(10) Pub. No.: US 2017/0112705 A1
(43) Pub. Date: Apr. 27, 2017

(54) Staircase Gait System and Methods

(71) Applicant: REHABILITATION INSTITUTE OF CHICAGO, Chicago, IL (US)

(72) Inventors: George Hornby, Chicago, IL (US); Joanne C. Smith, Chicago, IL (US)

(21) Appl. No.: 15/331,537

(22) Filed: Oct. 21, 2016

Related U.S. Application Data
(60) Provisional application No. 62/244,286, filed on Oct. 21, 2015.

(51) Int. Cl. A61H 3/00; A63B 23/035; A63B 21/00; A63B 23/02

(52) U.S. Cl. CPC A61H 3/008; A63B 23/0238; A63B 23/03516; A63B 21/4009; A63B 21/4027; A61H 2003/001

(57) ABSTRACT

A staircase gait system and related methods are disclosed. A related apparatus can include a support element positioned above a staircase, a connector element coupled to the support element, and a harness having a first end attached to the connector element and a second end configured to be secured to a patient, wherein the apparatus is configured to prevent the patient from falling down the staircase.

### CROSS-REFERENCE TO RELATED APPLICATIONS

The present application claims priority to U.S. Provisional Patent Application 62/244,286 filed on Oct. 21, 2015, which is incorporated herein by reference in its entirety.

### TECHNICAL FIELD

The present disclosure is generally directed to systems and methods of physical rehabilitation and, more particularly, to staircase gait systems for physical rehabilitation and related methods.

### BACKGROUND

People who suffer from a spinal cord injury, a stroke, or another physical condition can benefit from physical therapy. One type of task a patient may perform during physical therapy is gait training, where the patient practices walking, often with the help of a physical therapist.

The type of therapy a stroke patient receives can have a significant impact on his or her ability to recover. Recent research suggests that simply walking on a flat treadmill can limit the extent of the patient's recovery, and that training with variable challenges, such as requiring the patient to step in multiple directions, over obstacles, or up and down stairs, can help improve recovery.

However, gait training that requires a variety of challenging locomotor tasks can be discouraged in a rehabilitation setting. Post-stroke patients can have many gait impairments, and often cannot climb staircases during therapy out of safety concerns. Some physical therapists physically assist patients up and down staircases during therapy. However, successfully providing this kind of therapy for many patients in a day is strenuous for the therapist and increases the risk of fall and injury.

### SUMMARY

This disclosure is directed to a staircase gait system and related methods. In an embodiment, the system may include an apparatus that comprises a support element positioned above a staircase. The staircase may comprise a lower portion adjacent to a landing and an upper portion adjacent to a balcony. A connector element may be coupled to the support element. The apparatus may include a harness having a first end attached to the connector element and a second end configured to be secured to a patient. The apparatus may be configured to prevent the patient from falling down the staircase, for instance if the patient were to trip or to fall while using the apparatus.

In an embodiment, the support element may comprise a rail positioned over the staircase.

In an embodiment, at least a portion of the support element is parallel to the slope of the staircase at the position below the portion of the support element.

In an embodiment, the staircase further comprises a level landing and the support element is parallel to the level landing.

In an embodiment, the level landing is positioned between the lower portion of the staircase and the upper portion of the staircase.

In an embodiment, the support element is configured to allow the patient to ascend the lower portion to a position on the staircase below the balcony, reverse direction, and descend the lower portion.

In an embodiment, the support element is configured to allow the patient to ascend the lower portion of the staircase on a first side of the staircase and to descend the lower portion of the staircase on a side of the staircase opposite to the first side.

In an embodiment, the apparatus may comprise a transfer element that transfers the first end of the harness from the connector element to a level gait track.

In an embodiment, the transfer element is positioned above the staircase landing.

In an embodiment, the connector element is movable to stay positioned above the patient while ascending and descending the staircase.

In an embodiment, the connector element is movable through the use of a wireless remote control.

In an embodiment, a rail system for use in rehabilitation comprises a rail that may be positioned above a staircase. The rail may have a first end positioned above a bottom portion of the staircase. The rail may extend from the first end to a position above a top portion of the staircase. A portion of the rail may extend parallel to an incline of the staircase. The rail may comprise a rack positioned along a bottom face of the rail, and the rack may comprise a plurality of teeth for attachment to a motorized carrier. The first end of the rail may be positioned substantially adjacent to a first end of a ceiling gait track, for the transfer of a patient from the rail to the ceiling gait track.

### BRIEF DESCRIPTION OF THE DRAWINGS

Various embodiments of are described herein by way of example in conjunction with the following figures.

FIG. 1 illustrates a top view of an embodiment of a staircase gait system.

FIG. 2 illustrates a perspective view of an embodiment of a connection between a staircase rail and a ceiling track.

FIG. 3 illustrates a perspective view of an embodiment of a connector element.

FIG. 4 illustrates a bottom view of an embodiment of a rail comprising a rack with teeth for attachment to a motorized carrier.

FIG. 5 illustrates a remote control for an exemplary staircase gait system.

FIG. 6 illustrates a perspective view of an embodiment of a staircase gait track positioned over a staircase.

FIG. 7 illustrates a perspective view of an embodiment of a portion of a support mechanism positioned over a staircase.

FIG. 8 illustrates an embodiment of a ceiling track positioned adjacent to an embodiment of a staircase rail.

### DETAILED DESCRIPTION

The staircase gait apparatus may comprise a support element positioned above a staircase. In an embodiment, the support element may comprise one or more rails that may be mounted or hung over a staircase or other set of stairs. The rails may be mounted so that they are elevated above the staircase and may run parallel to the stairs. A connector element may be coupled to the rails, and a harness may be attached to the connector element. At the second end of the harness there may be straps or other suitable attachments. A patient, research subject, or other user of the apparatus (all referred to herein generally as a “patient”) may be strapped in or otherwise secured to the harness. After being secured to the harness, the apparatus permits the patient to ascend or descend the staircase. The apparatus can provide a lifting force to assist the patient in ascending or descending the stairs. Alternately, the apparatus can provide no lifting force to assist the patient in ascending or descending the stairs, therefore requiring the patient to ascend or descend using only the force from his or her muscles and other body structures. If the patient trips, stumbles, or otherwise falls while using the system, the system can be configured to prevent the patient from falling down the staircase, therefore preventing injury to the patient.

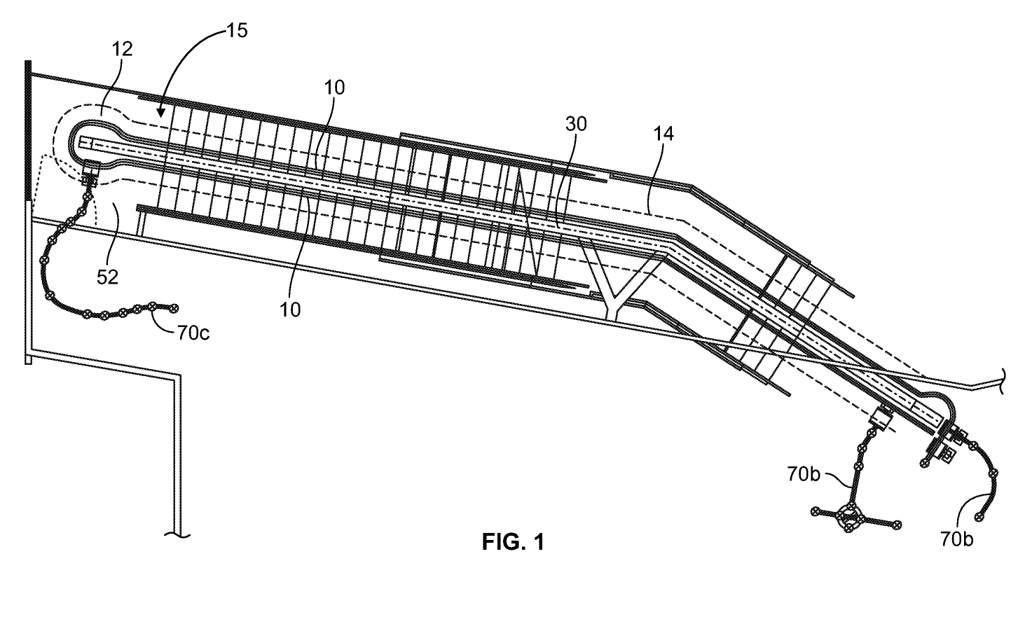

FIG. 1 illustrates a top view of an embodiment of a staircase gait system. In an embodiment, a patient can walk up and down the length of the staircase with the support of a support element 15 which, in the illustrated embodiment, includes a rail 10. The shape of the rail 10 may be designed to conform to the shape of the staircase underneath the rail 10. In an embodiment, a first portion of the rail 10 may be positioned above and to the left of the center of the staircase. A second portion of the rail 10 may be positioned above and to the right of the center of the staircase. The rail 10 may extend past the stairs, so that the rail 10 is additionally positioned above the staircase landing and/or the staircase balcony. This permits an additional physical space for a patient to be coupled to the rail 10 without interfering in other physical therapy or other activity that may be occurring on the staircase. On the landing or the balcony, the patient may be secured to a harness, the harness can be connected to a connector element, and the connector element can be connected to the support element 15 (for instance, to the rail 10).

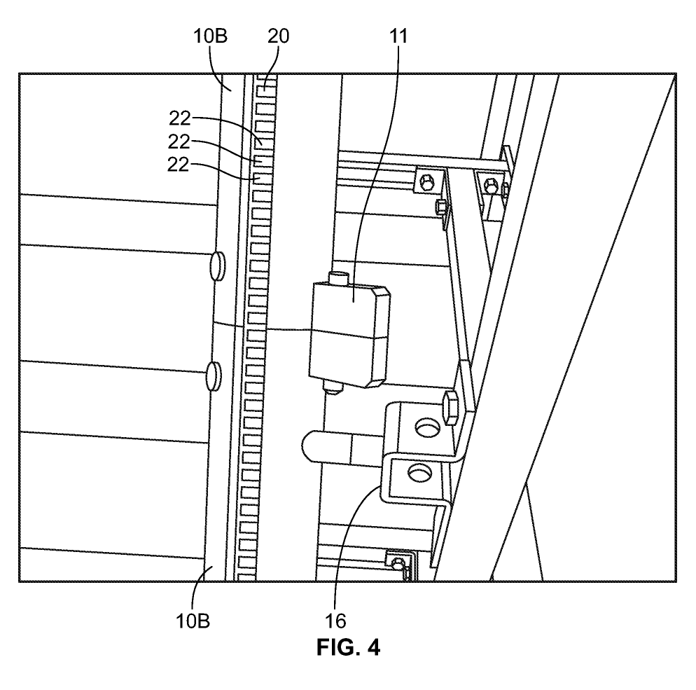

One or more portions of each rail 10 may be curved so that the patient is able to walk along a curved path while still being supported by the system. In the embodiment shown in FIG. 1, for instance, the landing rail portion 12 is the portion of the rail 10 that is positioned above the landing 52. The landing rail portion 12 is curved so that a patient can walk up the right-hand side of the staircase 50 and turn around on the landing 52 to walk down the staircase 50, along the stepping path 14, all without having to detach the harness from the rail 10. Each rail 10 may be made up of rail segments 10a, 10b, 10c, 10d, and 10e which may be interconnected and locked together using a lock, such as the lock 11, as illustrated in FIG. 4. Each rail segment 10s may be 16 feet in length or another suitable length.

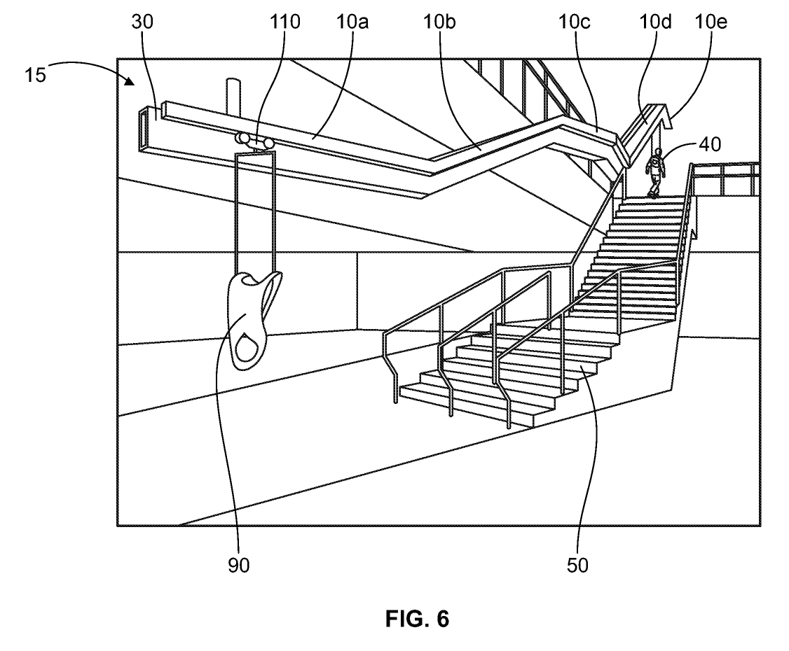

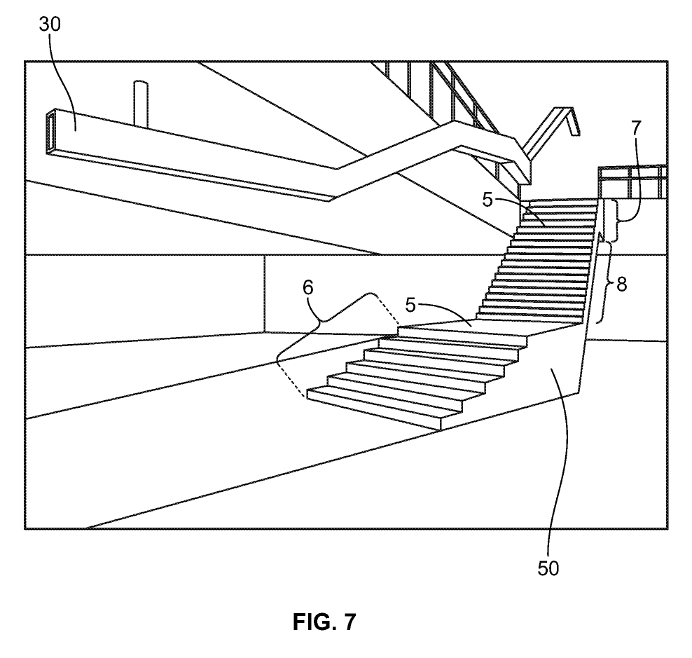

A beam 30 may be provided that attaches the support element 15 to the walls or ceiling of the building, so that the support element 15 is elevated above the staircase. As shown in FIG. 6 and FIG. 7, a beam 30 may be positioned above the staircase 50 and used to elevate the rail 10 above the staircase 50. In another embodiment, the beam 30 may include a truss with a bottom portion and a top portion, where the bottom portion is attached to the staircase 50 or to the ground and the top portion is attached to the rail 10.

The rail 10 may be attached to the building connector with support attachments 16 that are positioned along the length of the staircase rails 10. In an embodiment, the support attachments 16 are positioned every three feet or fewer along the length of the rail 10.

FIG. 7 illustrates a beam 30 positioned over the staircase 50. As shown in FIG. 7, the staircase 50 may comprise one or more intermediate landings 5, which are flat and run parallel to the ground. The intermediate landings 5 allow a patient the opportunity to rest during gait training on the staircase 50. As shown in FIG. 7, a first intermediate landing 5 is positioned between the lower set of stairs 6 and the middle set of stairs 8. A second intermediate landing 5 is positioned between the middle set of stairs 8 and the upper set of stairs 7. The bottom of the lower set of stairs 6 is adjacent to a landing and the top of the upper set of stairs 7 is adjacent to a balcony As shown in FIGS. 1 and 6-7, the staircase 50 may change direction as it raises, for instance by adjusting the angle at an intermediate landing 5, as shown in the figures.

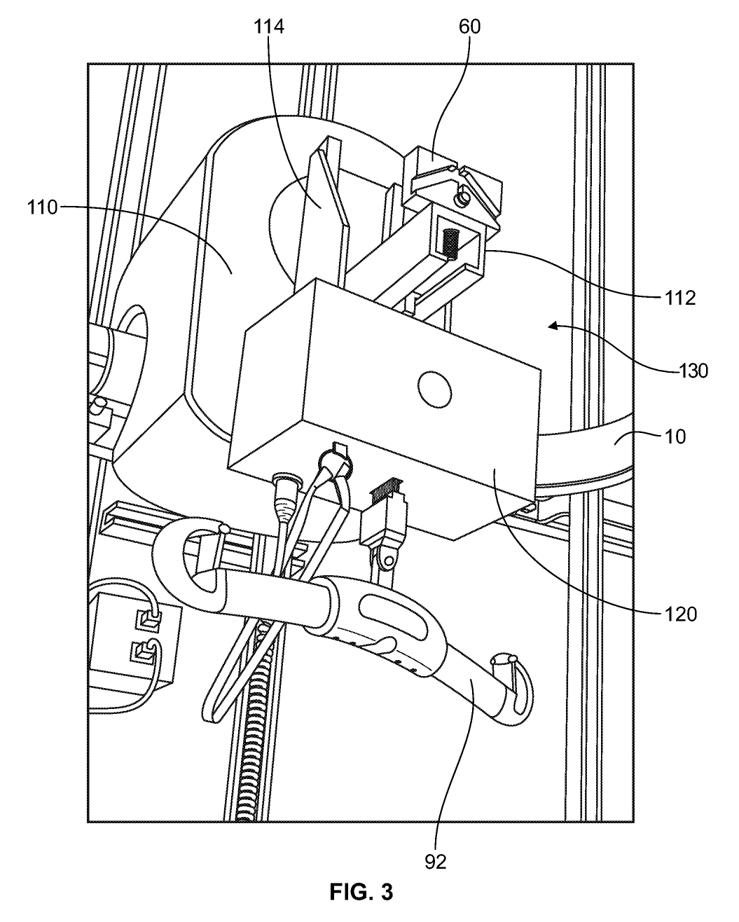

The support element 15 may further comprise a rack 20. For example, the rack 20 may be fitted to the underside of the rail 10. A connector element may be coupled to the support element 15. In an embodiment, the connector element may comprise a motorized carriage 110 and a trolley 120. FIG. 3 illustrates a perspective view of an embodiment of a connector element, generally labeled 130. The rack 20 includes a plurality of teeth 22 that engage with a pinion in the motorized carriage 110. The motorized carriage 110 may be configured so that it employs auto-horizontal articulation, which keeps the trolley 120 level with respect to the ground as the motorized carriage 110 traverses up and down an angled section of the rail 10. The motorized carriage 110 employs an internal pinion (not shown) that locks the motorized carriage 110 to the rack 20. This ensures that the motorized carriage 110 moves only at the command of a remote control 150. It also ensures that if the patient falls or stumbles, the motorized carriage 110 remains in place at its position on the rail 10. The motorized carriage 110 will not move even in response to the force from the patient's fall. As a result, the patient does not fall down the staircase. The motorized carriage 110 may employ redundant motors for additional safety. The trolley 120 may include a lift feature that raises and lowers the patient. For example, the trolley 120 may have a mechanism to increase and decrease the length of the strap 122, so that patients of different heights can use the gait track system for rehabilitation.

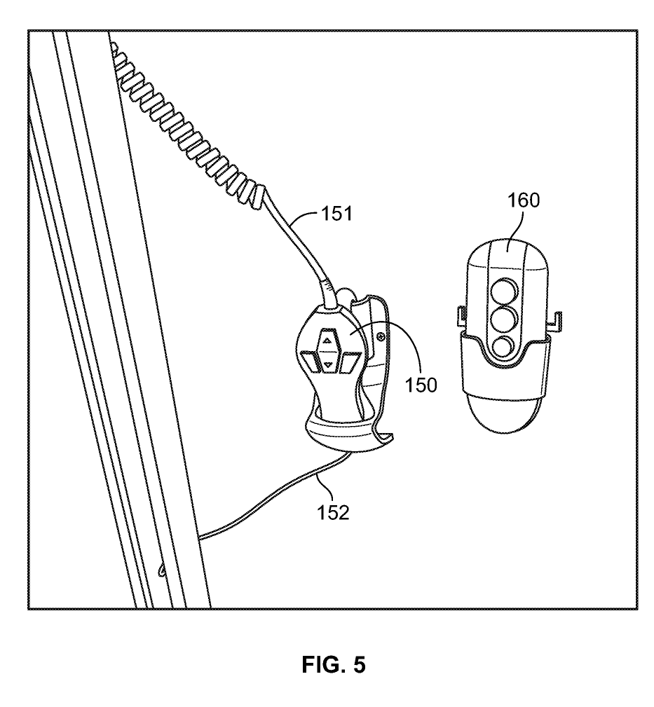

In an embodiment, the motorized carriage 110 may operate at a maximum speed of 0.4 meters per second (0.89 miles per hour) as it travels along the rack 10. The speed of the motorized carriage 110 may be adjustable by a remote control 150, shown in FIG. 5. For instance, the speed of the motorized carriage 110 may be adjusted upwards or downwards in preset increments. In another embodiment, the speeds may be preset to 0.40, 0.25 and 0.10 meters per second. It is preferred that the motorized carriage 110 be able to move immediately in response to a control from the remote control 150, and accelerate quickly to the preferred speed. Additionally, it is preferred that the motorized carriage 110 be able to stop quickly in response to a command.

Referring to FIG. 5, a remote control 150 may be provided to control the connector element 130. In an embodiment, all controls are provided for by the remote control 150, and the remote control 150 is operable with one hand, allowing a therapist to control the position and speed of the connector element 130 while using her or his other hand to guide the patient. In an embodiment, the motorized carriage 110 operates only while the therapist or other user of the system keeps a button pressed on the remote control 150. In this way, if the therapist needs to use both hands to assist the patient in an emergency, the therapist will release the remote control 150 and the motorized carriage 110 will stop as a result. A wireless remote control 160 may be employed in lieu of or in addition to the remote control 150.

In other embodiments, the connector element 130 may be comprised of more or fewer components than the embodiment shown in the figures. In various embodiments, the connector mechanism may be motorized. The connector element 130 may be configured to allow the patient to rotate three hundred and sixty degrees while in the harness. The staircase gait system may be used with an adult harness or with a pediatric harness. The harness material may be of a type suitable for cleaning and disinfecting in a medical care setting. For example, the harness material may be wiped with a germicidal disposable wipe or its equivalent after each patient use, in order to reuse the harness immediately.

In an embodiment, each staircase rail 10 may end at a rail connector 60. Each rail connector 60 connects a staircase rail 10 to a floor rail 70. Allowing the staircase rails 10 to be connected to a set of floor rails 70 allows the patient to transition between using the gait track system on a floor and using the system on the staircase 50. The rail connector 60 allows one section of rail merge with another without detaching the patient from the system.

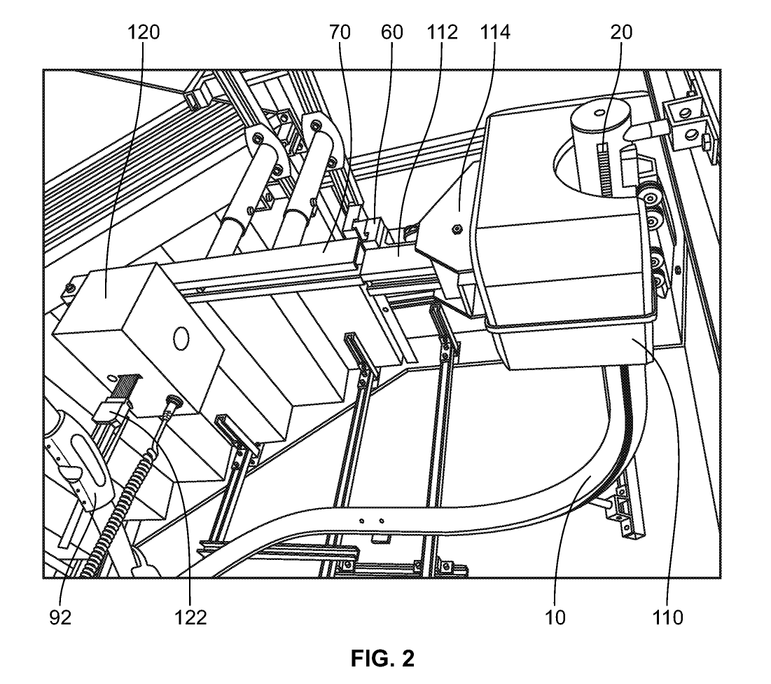

FIG. 2 illustrates an embodiment of the rail connector 60. A plate 114 is attached to the outer face of the motorized carriage 110 and a rail section 112 is attached to the plate 114. As the motorized carriage 110 travels to the end of rail 10, the rail section 112 aligns with the floor rail 70 so that the trolley 120 can travel from the rail section 112 to the floor rail 70. The rail connector 60 is composed of two metal components with an engage/disengage latch.

The embodiment shown in FIG. 1 allows for multiple users to use the rails 10 at the same time. In an embodiment, each ten feet of rail 10 can maintain the weight of an average patient. A patient may be fitted to a harness attached to a connector element connected to first rail segment 70a. The patient then moves along the first rail segment 70a and transitions to rail 10. The patient begins to walk along rail 10 until reaching the first stairs of the staircase 50. The patient then begins to climb the stairs, being supported by the system. For instance, the system can provide a partial lift to the patient so that the patient does not need to support his or her full weight. Alternately, the system can support the patient by providing no lifting force, but be positioned so as to catch the patient in the event of a stumble or trip, therefore preventing the patient from falling down the stairs. Additional patients may follow in a similar manner. In other embodiments, the rails may be positioned so that a faster patient may pass a slower patient. After ascending the staircase, the patient may turn around and descend the stairs. In some embodiments, the patient descends the stairs on the same side of the staircase. Alternately, the patient can descend the stairs on the opposite side of the staircase.

FIG. 6 illustrates the rail 10 positioned over the staircase 50, for use in rehabilitation. The rail 10 has a first end 10a positioned above the bottom of the staircase. The rail 10 extends from the first end 10a to a position above the top of the staircase. As shown in FIG. 6, the rail 10 begins with first end 10a and continues with segments 10b, 10c, 10d, and circular segment 10e. The rail 10 then continues along the opposite side of the support beam 30 until it returns to the bottom of the staircase. A patient may wear the harness 90 and walk up the right hand side of the staircase 50 with the support of the connector element. The connector element 130 comprising the motorized carriage 110 and the trolley 120 may be used in lieu of the connector element illustrated in FIG. 6. When the patient gets to the top of the staircase 50, the patient reverses direction, for example by walking in a circular direction under circular segment 10e, and walks back down the other side of the staircase 50. Alternately, the patient may transfer from the rail 10 to a gait track positioned on the upper floor, for instance using a connector like rail connector 60. In this way the patient is able to start gait training on a floor at the bottom of the staircase, walk up the staircase, and continue gait training therapy on the floor above the staircase, all without having to be removed from the system. As shown in FIG. 6, a patient (shown at the top of the staircase) can be assisted by a therapist during gait training.

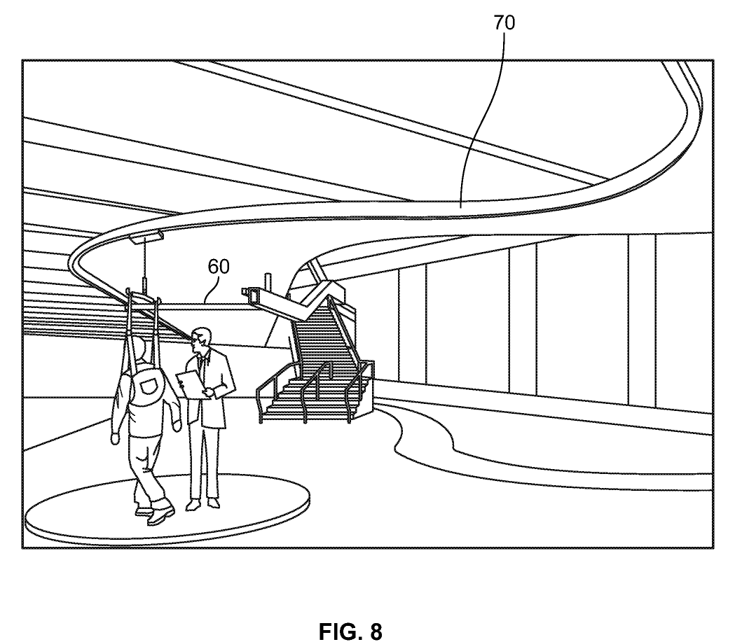

FIG. 8 illustrates a floor rail 70 positioned above a floor for patient use. The floor rail 70 has a first rail segment 70b with an end that is positioned adjacent to an end of the rail 10. The patient can transfer from the rail 10 to the rail segment 70b using, for example, a rail connector 60.

The various embodiments of the present invention have been described above in connection with a gait track system employing a rail structure. It should be noted, however, that in other embodiments, the inventive staircase gait track apparatus disclosed herein need not employ a rail structure system. For example, other mechanical systems may be used to achieve the same results.

Although the present invention has been described herein in connection with certain disclosed embodiments, many modifications and variations to those embodiments may be implemented. Where materials are disclosed for certain components, other materials may be used. The foregoing description and following claims are intended to cover all such modification and variations. Those familiar with the art to which this invention relates will recognize various alternative designs and embodiments for practicing the invention within the scope of the appended claims.

What is claimed is:

1. An apparatus, comprising:
a. a support element positioned above a staircase, the staircase comprising a lower portion adjacent to a landing and an upper portion adjacent to a balcony;
b. a connector element coupled to the support element;
c. a harness having a first end attached to the connector element and a second end configured to be secured to a patient;
wherein the apparatus is configured to prevent the patient from falling down the staircase.

2. The apparatus of claim 1, wherein the support element comprises a rail positioned over the staircase.

3. The apparatus of claim 1, wherein at least a portion of the support element is parallel to the slope of the staircase at the position below the portion of the support element.

4. The apparatus of claim 2, wherein the staircase further comprises an intermediate landing and wherein the support element is parallel to the intermediate landing.

5. The apparatus of claim 4, wherein the intermediate landing is positioned between the lower portion of the staircase and the upper portion of the staircase.

6. The apparatus of claim 1, wherein the support element is configured to allow the patient to ascend the lower portion to a position on the staircase below the balcony, reverse direction, and descend the lower portion.

7. The apparatus of claim 6, wherein the support element is configured to allow the patient to ascend the lower portion of the staircase on a first side of the staircase and to descend the lower portion of the staircase on a second side of the staircase opposite to the first side.

8. The apparatus of claim 1, further comprising a transfer element that transfers the first end of the harness from the connector element to a level gait track.

9. The apparatus of claim 1, wherein the transfer element is positioned above the staircase landing.

10. The apparatus of claim 1, wherein the connector element is movable to stay positioned above the patient while ascending and descending the staircase.

11. The apparatus of claim 10, wherein the connector element is movable through the use of a wireless remote control.
